(19) United States
(12) Patent Application Publication
(10) Pub. No.: US 2012/0274056 A1
(43) Pub. Date: Nov. 1, 2012

(54) SAFETY SEATBELT SYSTEM FOR PREGNANT WOMEN

(76) Inventors: RICHARD DEAN FAN, Mission Viejo, CA (US); PETE CALDERON, JR., Mission Viejo, CA (US)

(21) Appl. No.: 13/543,767

(22) Filed: Jul. 6, 2012

Related U.S. Application Data
(63) Continuation-in-part of application No. 13/182,967, filed on Jul. 14, 2011.
(60) Provisional application No. 61/369,827, filed on Aug. 2, 2010.

(51) Int. Cl. B60R 22/14; B60R 22/00

(52) U.S. Cl. 280/801.1

(57) ABSTRACT

A safety seatbelt system for pregnant women comprising: a ballistic nylon webbing restraint harness having a profile providing an open abdominal area for accommodating a developing fetus within the pregnant passenger; an attachment strap having a female end that wraps around the posterior region of a seat in a vehicle; a chest and thigh engaging portion, such that a chest of the pregnant passenger is suitably restrained from forward movement in the event of a collision; at least two threadable clips to provide side adjustment; and a back strap. The restraint harness has a top female end and bottom male end along with several additional male ends. The restrain harness provides attachment points on both bottom sides of the restrain harness such that the restrain harness can be removably affixed to the OEM seatbelt assembly in the vehicle.

### CROSS-REFERENCE TO RELATED APPLICATION

This application is a continuation in part of non-provisional patent application Ser. No. 13/182,967 filed on Jul. 14, 2011, which is currently pending. Applicant claims priority to the filing date of non-provisional patent application Ser. No. 13/182,967, which in turn claims the priority filing date of provisional patent application No. 61/369,827 filed on Aug. 2, 2010. The prior applications are incorporated herein by reference.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The following includes information that may be useful in understanding the present invention(s). It is not an admission that any of the information provided herein is prior art, or material, to the presently described or claimed inventions, or that any publication or document that is specifically or implicitly referenced is prior art.

The present invention relates generally to the field of seatbelt harnesses and more specifically relates to a seatbelt harness for use on pregnant drivers and passengers to prevent the death or injury to unborn fetuses during vehicular accidents. The seatbelt harness may also be used for obese people.

A seatbelt, sometimes called a safety belt, is a safety harness designed to secure the occupant of a vehicle against harmful movement that may result from a collision or a sudden stop. As part of an overall automobile passive safety system, seat belts are intended to reduce injuries by stopping the wearer from hitting hard interior elements of the vehicle, or other passengers (the so-called second impact), keep the wearer in the correct position for the airbag to deploy and prevent the wearer from being thrown into the windshield or from the vehicle. Seatbelts also absorb energy by being designed to stretch during sudden deceleration. So that there is less speed differential between the passenger's body and their vehicle interior, and also to spread the loading of impact on the passenger's body. However, there are many shortcomings in current seatbelt systems.

In pregnancy, there can be multiple gestations, as in the case of twins or triplets. Childbirth usually occurs about 38 weeks after conception; in women who have a menstrual cycle of four weeks, this is approximately 40 weeks from the last normal menstrual period (LNMP). During this time expectant mothers may be traveling using seatbelts, causing potential danger to the fetus.

Individuals should always wear a seatbelt, even while pregnant. However, wearing a lap belt across one's pregnant abdomen can be dangerous. In the event of an accident, the lap belt could potentially cause severe harm to the unborn child. The belt is often positioned over the top of the baby, and in a collision can cause trauma to the child. Death is even a possibility depending on the severity of the accident and the position of the lap belt. Pregnant woman are often uncomfortable with the idea of not wearing a seatbelt, but also want to protect their child from seatbelt trauma. A more efficient seatbelt option is needed.

Various attempts have been made to solve the above-mentioned problems such as those found in U.S. Pat. No. 5,215,354; 2002/0140279; 2005/0110316; U.S. Pat. Nos. 5,005,865; 6,935,700; 4,610,463; and 5,915,789. The prior art is representative of seatbelts. None of the above inventions and patents, taken either singly or in combination, describe the invention as claimed.

Ideally, a safety seatbelt system for pregnant women should be safe, user-friendly, easy to install and yet, operate reliably, and be manufactured at a modest expense. Thus, a need exists for a reliable safety seatbelt system for pregnant woman that protects unborn fetuses in the event of a vehicular accident.

### SUMMARY

In view of the foregoing disadvantages inherent in the known seatbelt harness art, the present invention provides a novel safety seatbelt system for pregnant woman. The general purpose of the present invention, which will be described subsequently in greater detail, is to provide a safety seatbelt usable by pregnant woman that protects unborn fetuses in the event of a vehicular accident.

The present invention, safety seatbelt system for pregnant woman, as disclosed herein preferably comprises: a standard seatbelt webbing restraint harness having a profile providing an open abdominal area for accommodating a developing fetus within the pregnant passenger; a chest engaging portion such that the chest of the pregnant passenger is suitably restrained from forward movement in the event of a collision; a thigh engaging portion with at least one crotch buckle such that the hips and lower extremities of the pregnant passenger is suitably restrained from forward movement in the event of a collision; a back strap; and at least two threadable clips to provide adjustment. The restraint provides attachment points on both bottom sides and top of the restraint harness such that the restraint harness can be removably affixed to the OEM (original equipment manufacturer) seatbelt assembly in the vehicle.

Further, the invention preferably comprises an additional attachment point for the restraint harness and a perineal belt. A base strap that wraps around the posterior base region of a seat backrest can provide for this additional attachment point for the restraint harness. A perineal belt, extending from the rear of the passenger through the gluteal area to the pubis engages the thigh portion of the restraint harness, providing for a crotch restraint.

The restraint harness further comprises a back strap that wraps over a shoulder of a passenger behind the vehicle seat and connects to the perineal belt. The back strap distributes forces/stresses incurred by the safety harness over an increased surface area also providing comfort to the pregnant passenger. The restraint harness further preferably comprises a chest-engaging portion such that a chest of the pregnant passenger is suitably restrained from forward movement in the event of a collision.

The profile providing an open abdominal area circumvents the developing fetus. The profile of the restraint harness is given a larger surface area of contact with the pregnant passenger, thereby directing the force around where the developing fetus is growing to provide a safety zone for the fetus. The threadable clips on the restraint harness permit the harness to be adjustable and accommodate a relative size of the developing fetus within the confines of the mother, and the mother herself.

A kit is also embodied herein for the safety seatbelt for pregnant woman system comprising; a restraint harness; at least one attachment strap; and a set of user instructions for installation and use.

In accordance with the embodiments of the present invention a preferred method of use is disclosed herein preferably comprising: step one, removably-attaching a base strap around the seat back of a pregnant passenger; step two, placing a restraint harness over a head of a pregnant passenger; step three, removably-attaching a female end of the restraint harness to a male end of an OEM seatbelt assembly in a vehicle; step four, removably-attaching a male buckle to a female end of an OEM seatbelt assembly in a vehicle; step five, removably-attaching an additional male buckle to the base strap; step six, removably-attaching the restraint harness to the perineal belt between a pregnant passenger's legs using the crotch buckle; step seven, adjusting the restrain harness around a periphery of a developing fetus within the pregnant passenger; and step eight, adjusting the restraint harness to a user-preferred tightness thereby securing the pregnant passenger (and the unborn fetus) safely into the seat of the vehicle.

The present invention holds significant improvements and serves as a safety seatbelt system for pregnant woman. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### DRAWINGS

The figures which accompany the written portion of this specification illustrate embodiments and method(s) of use for the present invention, safety seatbelt system for pregnant women, constructed and operative according to the teachings of the present invention.

FIG. 1 shows a perspective view illustrating the restraint harness of the safety seatbelt system for pregnant women according to an embodiment of the present invention.

FIG. 2 shows a perspective view illustrating the base strap of the safety seatbelt system for pregnant women according to an embodiment of the present invention.

FIG. 3 shows a perspective view illustrating the perineal belt of the safety seatbelt system for pregnant women according to an embodiment of the present invention.

FIG. 4 shows a perspective view illustrating a safety seatbelt system for pregnant women in an ‘in-use’ condition according to an embodiment of the present invention.

FIG. 5 shows a front perspective view illustrating a restraint harness removably- attached to a pregnant passenger of the safety seatbelt system for pregnant women according to an embodiment of the present invention.

FIG. 6A shows a perspective view illustrating the attachment straps from the rear of a seat assembly of the safety seatbelt system for pregnant women according to an embodiment of the present invention.

FIG. 6B shows another perspective view illustrating the attachment straps from the front of the seat assembly of the safety seatbelt system for pregnant women according to an embodiment of the present invention.

FIG. 7 shows a front perspective view of the perineal belt buckle assembly according to an embodiment of the present invention.

FIG. 8 is a flowchart illustrating a method of use for the safety seatbelt system for pregnant women according to an embodiment of the present invention of FIGS. 1-7.

The various embodiments of the present invention will hereinafter be described in conjunction with the appended drawings, wherein like designations denote elements.

### DESCRIPTION

As discussed above, embodiments of the present invention relate to the field of seatbelt harnesses and more specifically relates to a seatbelt harness for use on pregnant women to prevent the death or injury of unborn fetuses in vehicular accidents.

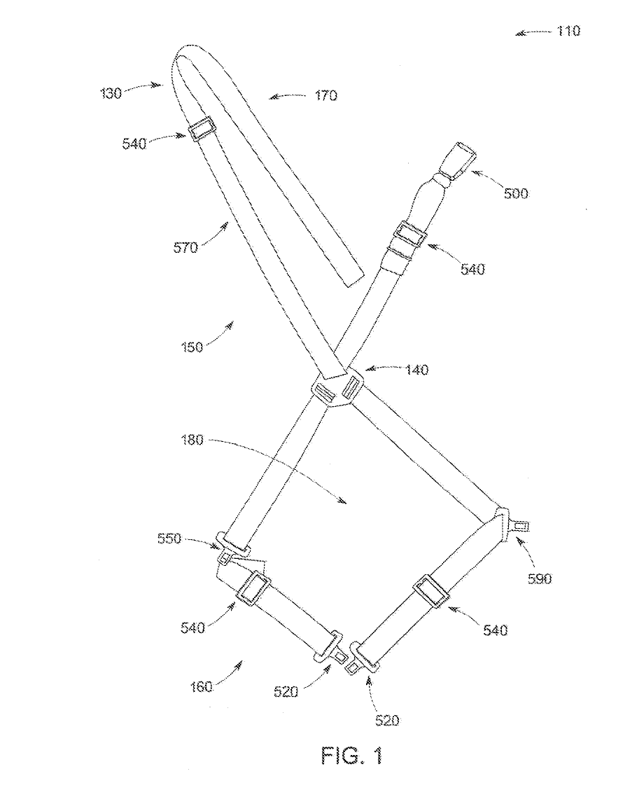

Referring now to FIG. 1 showing the restraint harness 110 preferably comprising a chest engaging portion 150 with a crisscross configuration, a thigh engaging portion 160 that extends from the outer hips over the thighs to the crotch region, and a back strap 170. The crisscross configuration of the restraint harness 110 provides for an open abdominal area 180 for accommodating a developing fetus. The crisscross configuration is achieved by use of a chest plate 140. Restraint harness 110 is preferably comprised of webbing. The webbing may be of the type regularly used in the seatbelt industry. Upon reading this specification, it should be appreciated that, under appropriate circumstances, considering such issues as user preferences, design preference, structural requirements, marketing preferences, cost, available materials, technological advances, other webbing configurations or types of nylon, various suitable fabrics may be sufficient.

FIG. 1 illustrates the restraint harness 110 preferably comprising several attachment points. Attachment of the restraint harness 110 to the OEM seatbelt assembly 600 is carried out using top female buckle 500 and bottom male buckle 550. Additional attachments points are provided by male buckle 590, male crotch buckles 520, and back strap 170. Adjustment of the restraint harness is possible using threadable clips 540 such as a tri-bar or D-ring.

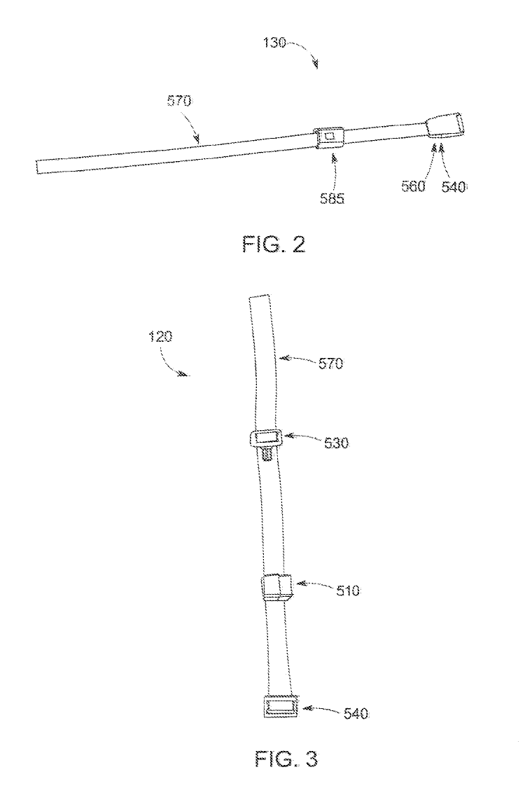

FIG. 2 illustrates a base strap 130 that can be removably-attached around the posterior of OEM seat. The base strap 130 is preferably comprised of webbing and includes a female buckle 585 where the male buckle 590 of the restrain harness 110 may be attached. The base strap 130 further comprises a threadable clip 540 and/or base strap connector 560 to allow for installation, adjustment, and removal of the strap.

FIG. 3 illustrates a perineal belt 120 to provide an attachment point for the thigh engaging portion 160 of the restrain harness 110. The perineal belt 120 preferably comprises webbing and provides for at least one female crotch buckle 510 where at least one male crotch buckle 520 of the thigh engaging portion 160 of the restraint harness 110 may attach. An embodiment of the crotch buckle assembly 505 is illustrated in FIG. 7. The perineal belt 120 may further comprises a threadable clip 540 to allow for installation, adjustment, and removal of the belt.

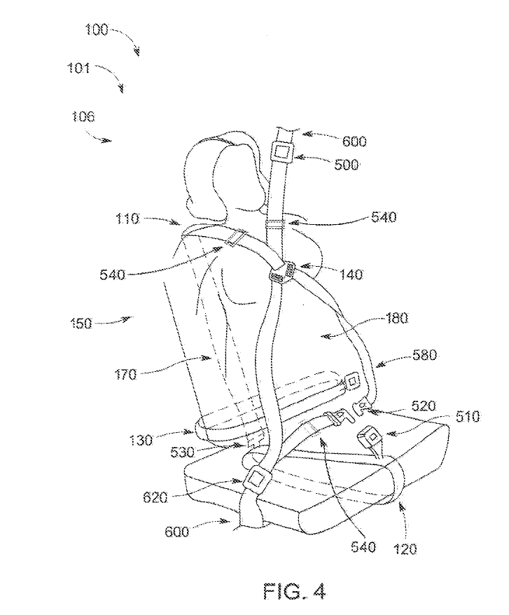

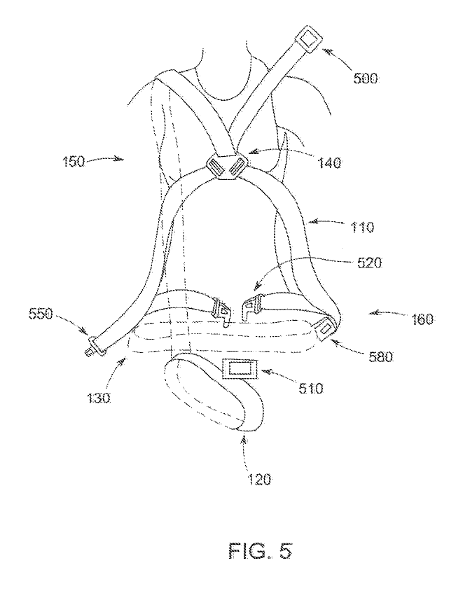

Referring now to FIGS. 4-5 showing perspective views of safety seatbelt system for pregnant women 100 in an ‘in-use’ condition 106 according to embodiments of the present invention. Safety seatbelt system for pregnant women 100 designed to prevent the death or injury of unborn fetuses in car accidents preferably comprises an attachment to existing (OEM) vehicle seatbelts. Pregnant passenger 101 may use this novel safety device in their vehicles to provide supplemental protection to the stomach area in the event of an accident. Furthermore, safety seatbelt system for pregnant women 100 improves upon the traditional lap belt by dispensing force of impact, which can limit harm to the fetus (and expectant mother) during a collision.

FIG. 5 showing a front perspective view of safety seatbelt system for pregnant women 100 illustrating restraint harness 110 removably-attached to pregnant passenger 101 according to an embodiment of the present invention.

As best shown in FIG. 4-5 The profile providing an open abdominal area 180 of restraint harness 110 preferably circumvents the fetus. A primary benefit of having circumvention of the developing fetus when safety seatbelt system for pregnant women 100 is in an ‘in-use’ condition 106 on a pregnant passenger 101 is that restrain harness 110 is given a larger surface area of contact with pregnant passenger 101. Having a larger surface area of contact, and directing force around where the developing fetus is growing, provides a safety zone provided for the developing fetus.

FIG. 4 shows how the chest engaging portion 150 of the restraint harness 110 restrains forward movement of a pregnant passenger 101 in the event of a collision. Located on the chest engaging portion, providing an open abdominal area 180 on restraint harness 110, may be threadable clips 540 to provide adjustment of the harness by loosening or tightening a strap threaded through the clips 540. Located on the lower, thigh engaging portion 160 of the restraint harness 110 may be additional threadable clips 540 to provide adjustment for a growing fetus especially during the last trimester of a pregnancy. Threadable clips 540, such as tri-bars or D-rings, may be used in conjunction with a hook and loop fastener system (or other suitable fastening means) to allow for a user-adjustable fastening system.

The restraint harness further comprises a back strap 170. Back strap 170 may include a 2-inch webbing strap to preferably distribute tension caused by forward movement of passenger over an increased surface area, thereby also providing comfort and safety to pregnant passenger 101 as shown in FIG. 4.

Attachment of the safety seatbelt system for pregnant women 100 is illustrated in FIGS. 4-5. Restraint harness 110 provides for attachment points on the chest engaging portion 150 and thigh engaging portion 160. The chest engaging portion 150 of restraint harness 100 is connected to OEM seatbelt assembly 600 with top female buckle 500 and using back strap 170 wrapped over the pregnant passenger's shoulder and connected to perineal belt 120. The thigh engaging portion 160 of restraint harness 100 is connected using OEM seatbelt assembly 600 with female hip buckle 620, and buckle 580 connected to base strap 130. The thigh engaging portion 160 is further connected by engaging male crotch buckles 520 with female crotch buckle 510 at the perineal belt 120 as best illustrated in FIG. 5.

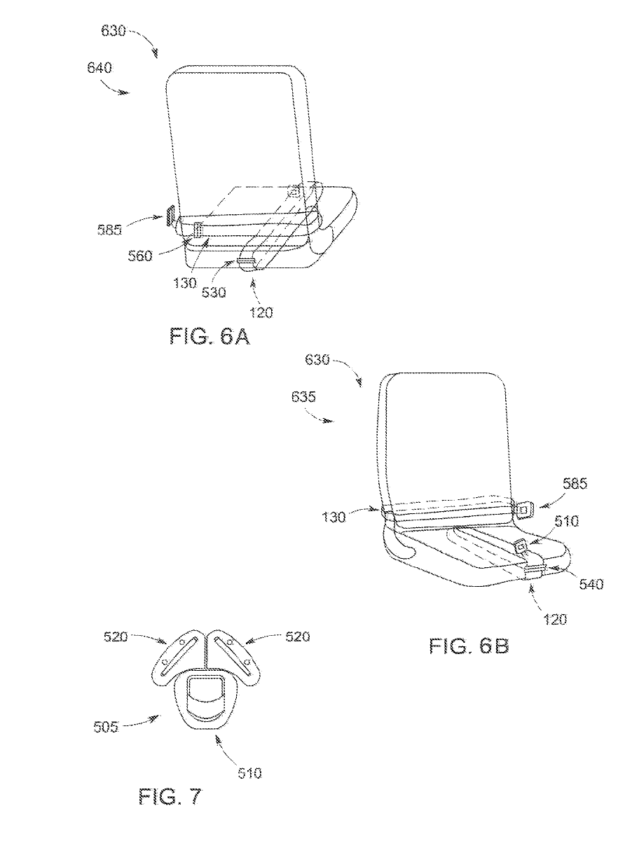

FIGS. 6A-6B illustrate attachment of the base strap 130 and perineal belt 120 to the vehicle seat 630. The base strap 130 may be affixed at the posterior of the seat by wrapping it around the seat back and engaging base strap connector 560 so that male buckle 590 on the restraint harness 110 can connect with female buckle 585 on the base strap 130. The perineal belt 120 may be affixed by wrapping it around the bottom portion of the vehicle seat 630 so that connection 530 can be used as an attachment point for back strap 170. Both base strap 130 and perineal belt 120 may include threadable clips 540 such as tri-bars or D-rings to allow for installation, adjustment, and removal of the straps.

FIG. 7 illustrates an embodiment of the crotch buckle assembly 505 composed of two male crotch buckles 520 and a female crotch buckle 510.

Safety seatbelt system for pregnant women 100, according to embodiments of the present invention of FIGS. 1-7, may be in the form of a kit comprised of the following parts: restraint harness 110; at least one attachment strap such as base strap 130 or perineal belt 120; and a set of user instructions for installation and use.

Upon reading this specification, it should be appreciated that, under appropriate circumstances, considering such issues as design preference, user preferences, marketing preferences, cost, structural requirements, available materials, technological advances, other kit contents or arrangements such as, for example, including more or less components, customized parts, different anchoring combinations, parts may be sold separately.

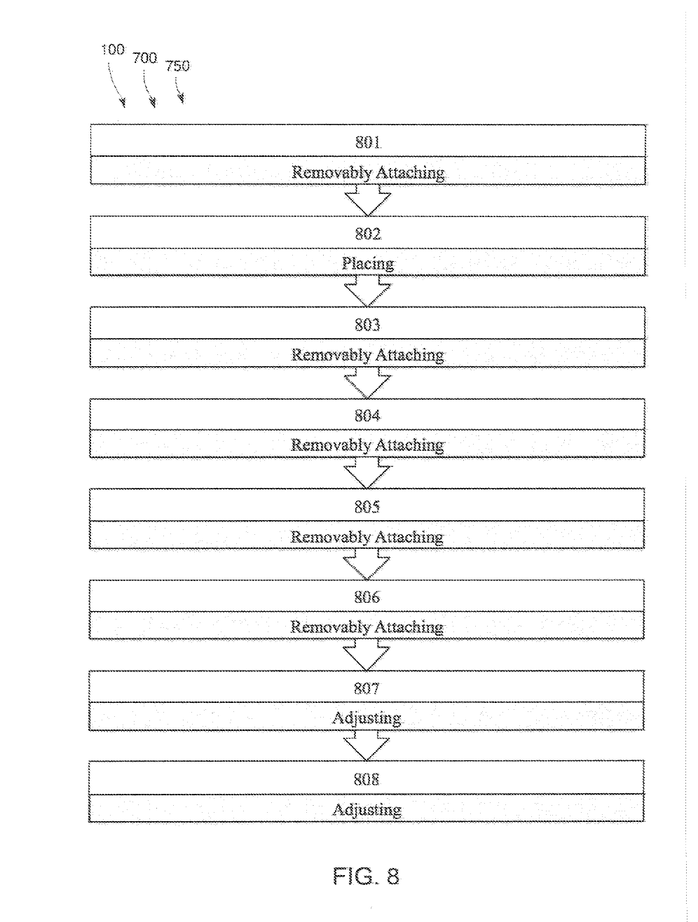

Referring now to FIG. 8. Showing flowchart 750 illustrating method of use 700 according to an embodiment of the present invention of FIGS. 1-7. A method of using (at least herein enabling method of use 700) safety seatbelt system for pregnant women 100 may comprise the steps of: step one 801 removably-attaching a base strap 130 around the back 640 of a pregnant passenger's 101 seat; step two 802 placing a restraint harness 110 over a head of a pregnant passenger 101; step three 803 removably-attaching a female end of the restraint harness 500 to a male end of an OEM seatbelt assembly 600 in the vehicle; step four 804 removably-attaching a male buckle 550 to a female end of an OEM seatbelt assembly in a vehicle 620; step five 805 removably-attaching an additional male buckle 590 to female buckle 585 on the base strap 130; step six 806 removably-attaching thigh engaging portion 160 of restraint harness 110 to perineal belt 120 between a pregnant passenger 101 legs using male crotch buckle(s) 520 and female crotch buckle(s) 510; step seven 807 adjusting the chest engaging portion 150, and thigh engaging portion 160, of restrain harness 110 around a periphery of a developing fetus within the pregnant passenger; step eight 808 adjusting the restraint harness 110 to a user-preferred tightness thereby securing the pregnant passenger 101 (and the unborn fetus) safely into the seat of the vehicle 630.

It should be noted that the steps described in the method of use could be carried out in many different orders according to user preference. Upon reading this specification, it should be appreciated that, under appropriate circumstances, considering such issues as design preference, user preference, marketing preferences, cost, structural requirements, available materials, technological advances, other methods of use arrangements such as for example, different orders with above-mentioned list, elimination or addition of certain steps, including or excluding certain maintenance steps, may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially scientists, engineers and practitioners in the art who are not familiar with patent or legal terms or phraseology, to determine quickly from a cursory inspection the nature and essence of the technical disclosure of the application.

What is claimed:

1. A safety seatbelt system for pregnant women or obese drivers comprised of
a restraint harness with a chest engaging portion for suitably restraining the chest of a pregnant passenger from forward movement in the event of a collision;
at least one attachment strap for affixing the restraint harness to a seat assembly, and a back strap that wraps over a shoulder of a passenger behind a vehicle seat and connects to the at least one attachment strap;
wherein the chest engaging portion has a crisscross configuration providing for an open abdominal area for accommodating a developing fetus, and
wherein the restraint harness comprises a top female buckle for connecting the restraint harness to an OEM seatbelt assembly.

2. The safety seatbelt system of claim 1, wherein the crisscross configuration is achieved by use of a chest plate.

3. The safety seatbelt system of claim 1, wherein the restraint harness further comprises a thigh engaging portion for suitably restraining the hips and lower extremities of a pregnant passenger from forward movement in the event of a collision.

4. The safety seatbelt system of claim 3, wherein the thigh engaging portion comprises at least one male crotch buckle.

5. The safety seatbelt system of claim 3, wherein the thigh engaging portion comprises at least one male buckle that attaches to a female buckle of a base strap, and at least one male buckle that attaches to an OEM vehicle seat belt.

6. The safety seatbelt system of claim 1, wherein the at least one attachment strap is a base strap that is removably-attached around a posterior of a vehicle seat.

7. The safety seatbelt system of claim 1, wherein the at least one attachment strap is a perineal belt extending from the rear of the passenger through the gluteal area to the pubis engages the thigh portion of the restraint harness, providing for a crotch restraint.

8. The safety seatbelt system of claim 7, wherein the back strap connects to the perineal belt.

9. The safety seatbelt system of claim 7, wherein the back strap connects to the perineal belt by way of a back base strap connection.

10. The safety seatbelt system of claim 7, wherein perineal belt comprises at least one female crotch buckle.

11. The safety seatbelt system of claim 8, wherein the at least one female crotch buckle can accommodate two male buckles.

12. The safety seatbelt system of claim 1, wherein the restraint strap has at least threadable clip for adjusting the restraint harness around the body of a passenger.

13. The safety seatbelt system of claim 12, wherein the restraint strap has two threadable clips in the chest engaging portion and two threadable clips in the thigh engaging portion.

14. A method of using the safety seatbelt assembly of claim 1, comprising the steps of:
removably-attaching a base strap around a pregnant passenger's seat;
removably-attaching a perineal belt around the pregnant passenger's seat;
removably-attaching a back strap of a restraint harness to the base strap;
placing a restraint harness over the head of the pregnant passenger;
removably-attaching a female end of the restraint harness 500 to a male end of an OEM seatbelt assembly in a vehicle;
removably-attaching a male buckle of the restraint harness to a female end of an OEM seatbelt assembly in the vehicle;
removably-attaching an additional male buckle to a female buckle on the base strap;
removably-attaching a thigh engaging portion of the restraint harness to a perineal belt between a pregnant passenger's legs using at least one male crotch buckle and at least one female crotch buckle;
adjusting the chest engaging portion and thigh engaging portion of restrain harness around a periphery of a developing fetus within the pregnant passenger;
adjusting the restraint harness to a user-preferred tightness thereby securing the pregnant passenger and the unborn fetus safely into the seat of the vehicle.
